(19) United States
(12) Patent Application Publication
(10) Pub. No.: US 2014/0299018 A1
(43) Pub. Date: Oct. 9, 2014

(54) Wet Process for Recycling Asphalt Shingle in Asphalt Binder for Asphalt Paving Applications

(71) Applicants: Mostafa A. Elseifi, Baton Rouge, LA (US); Louay Mohammad, Baton Rouge, LA (US)

(72) Inventors: Mostafa A. Elseifi, Baton Rouge, LA (US); Louay Mohammad, Baton Rouge, LA (US)

(73) Assignee: Board of Supervisors of Louisiana State University and Agricultural and Mechanical College, Baton Rouge, LA (US)

(21) Appl. No.: 14/191,977

(22) Filed: Feb. 27, 2014

Related U.S. Application Data
(63) Continuation-in-part of application No. 13/987,325, filed on Mar. 5, 2013.
(60) Provisional application No. 61/614,546, filed on Mar. 23, 2012.

(51) Int. Cl. C09D 195/00

(52) U.S. Cl. CPC C09D 195/00
USPC 106/273.1

(57) ABSTRACT

A method is disclosed for recycling asphalt roofing shingles and incorporating them into hot mix asphalt for use in applications such as asphalt pavement construction. Unlike previous methods, the asphalt from ground shingles is mixed with and becomes an integral component of the asphalt binder, instead of acting primarily as part of the aggregate. The asphalt content of the shingles mixes with heated asphalt binder to produce a single asphalt phase, and the asphalt from the shingles acts as asphalt in the final composite.

This application is a continuation-in-part of co-pending nonprovisional application Ser. No. 14/______, filed Mar. 5, 2013; which nonprovisional application is a conversion of provisional application Ser. No. 61/772,734, filed Mar. 5, 2013; and which nonprovisional application claims the benefit of the Mar. 23, 2012 filing date of U.S. provisional patent application Ser. No. 61/614,546 under 35 U.S.C. §119(e). The complete disclosures of all priority applications are hereby incorporated by reference in their entirety.

This invention was made with government support under grants CMMI-1030184 and EPS-1003897 awarded by the National Science Foundation. The government has certain rights in the invention.

### TECHNICAL FIELD

This invention pertains to a method for mixing recycled asphalt roofing shingles with asphalt binder to produce a modified binder that is suitable for making hot mix asphalt for road construction or other asphalt-based products.

### BACKGROUND ART

The manufacture and use of asphalt-based products, especially asphalt roofing shingles, sooner or later results in considerable amounts of landfill waste. The Environmental Protection Agency has estimated that approximately 11 million tons of asphalt roofing shingles are placed in U.S. landfills each year. Better avenues for recycling asphalt shingles would reduce landfill waste, would help the environment, and could provide significant cost savings. The fee for disposing waste shingles in landfills can be as high as $90 to $100 per ton near large cities and even up to $200 or higher in certain California metropolitan areas. Depending on details of manufacture and weathering, recycled asphalt shingles (RAS) can contain about 15% to 35% of potentially recyclable asphalt. Recycling this asphalt could provide an annual savings of $1.1 billion in the United States alone, while simultaneously reducing energy consumption. However, the incorporation of recycled material should not adversely affect the quality of the finished product.

A product often used in road construction is hot mix asphalt (HMA). HMA is traditionally produced by combining aggregate (e.g., crushed stone) with asphalt binder, which is the tarry black “cement” that binds the aggregate into the composite product. HMA typically comprises about 5% asphalt binder, about 91% aggregate, and about 4% voids. Asphalt binder is typically the most expensive component. In recent years, the cost of asphalt has been steadily increasing, almost independent of the fluctuations in the price of petroleum.

Previous methods for recycling asphalt shingles in HMA have used a “dry” process. In “dry” processing, ground asphalt waste in the solid state is first added to the aggregate, and then asphalt binder is added to the intermediate mixture to produce the finished product. In the conventional dry process, tear-off asphalt shingles are ground to a typical particle size on the order of 2.35 to 12.5 mm, and these particles are then dry-blended with the aggregate. A drawback of this process is that there is high variability in the “useful” asphalt content, and the properties of the resulting product are therefore variable as well. Furthermore, much of the asphalt from the ground shingles effectively acts merely as an aggregate component, and it does not effectively blend with the asphalt binder. Thus in practice the asphalt from the shingles proves to be less useful than it potentially might be.

Asphalt shingles are the most popular roofing materials in the United States, making up about two-thirds of the residential roofing market. There are two principal types: organic and fiberglass. Organic shingles typically contain 30-35% asphalt, 5-15% mineral fiber, and 30-50% mineral- and ceramic-coated granules. Fiberglass shingles are more common, and typically contain 15-20% asphalt, 5-15% felt, 15-20% mineral filler, and 30-50% mineral- and ceramic-coated granules. Fiberglass shingles have a fiberglass-reinforced backing that is coated with asphalt and mineral fillers. Organic shingles have a cellulose-felt base made from paper.

The average life span of asphalt shingles varies depending on environmental conditions, typically ranging from 15-30 years. Weathering appears to accelerate in hot weather, with high daily temperature fluctuations, and with infiltration of water. Tear-off shingles often have a higher percentage of asphalt as they lose surface granules during weathering.

Since the early 1990s, a number of studies have evaluated the effect of recycled asphalt materials on the mechanical properties of HMA. Air-blown asphalt is typically used in asphalt shingles; it has a higher viscosity than the asphalt binder that is generally used in HMA. One study reported that the use of 5-10% RAS in an HMA mixture decreased tensile strength and creep stiffness, but improved resistance to moisture damage. The use of less than 7.5% RAS in HMA allowed lower levels of virgin asphalt binder to be used, while improving resistance to permanent deformation. Although the use of asphalt shingles improved the rutting resistance of HMA, the composites also had lower fatigue resistance and higher tendencies to crack at low temperature.

Another study found that a particular source of fiberglass shingles had a high percentage (approximately 35.5%) of aggregate that passed a 0.075 mm (No. 200) sieve. This level limited the percentage of asphalt shingles that could be introduced into an HMA mixture by a dry blending process. Field evaluation of HMA with 5% RAS that had been shredded to a particle size of 12.5 mm showed acceptable performance. However, stockpiling RAS at a plant can cause the material to stick together in hot weather due to its asphalt content. This factor, in addition to the substantial cost of adding extra bins at a manufacturing plant to hold RAS, causes many asphalt contractors to avoid using RAS.

Other methods for recycling asphalt shingles have used a “wet” method, in which RAS is ground and combined with a liquid to produce a mixture that can be directly used to make new asphalt products. For example, U.S. Pat. No. 5,098,025 discloses a method for recycling asphalt shingles in which RAS is ground to approximately 10 mesh in a liquid that might be either water, or a solvent such as mineral spirits or benzene. The temperature must not be allowed to become so hot that the asphalt particles start clumping together. Since the recycling process mixes RAS with a liquid such as water or solvent, the resulting liquid asphalt mixture is not well-suited for asphalt paving construction applications. Rather, the mixture was said to be useful for asphalt-impregnated fiberboard.

U.S. Pat. No. 6,290,152 discloses an asphalt recycling method in which RAS is simultaneously heated and milled to a fine mesh, after which it is maintained in suspension in liquid asphalt. The simultaneous heating and milling of the RAS requires a complex apparatus that requires continuous venting to release excess moisture and gases so that unsafe pressures do not build inside the milling apparatus. Processing additives, such as liquid asphalt, may be incorporated with the RAS during heating and milling. The final product is an asphalt slurry containing 50% or greater ground suspended solids. This product is not well-suited for asphalt pavement construction because of the stiff characteristics of the binder in the shingle waste.

Scrap tires have been recycled in HMA using a wet process to create what is commonly called “asphalt rubber” or “crumb rubber modifier.” U.S. Pat. No. 5,334,641 discloses a modified asphalt composition formed by blending HMA with finely ground scrap rubber. This approach has found wide acceptance in the United States, and is generally favored over dry blending of scrap tires. It has been commonly used by state agencies (e.g., Louisiana, Arizona) in asphalt paving construction projects.

U.S. Pat. No. 4,706,893 discloses a process for recycling asphalt shingles. Heated and dried aggregate is mixed with asphalt binder to form an asphalt paving composition. The shingles are reduced in size to particles that can be easily flowed and metered, and the resulting shingle particles are then heated to melt the asphalt. The aggregate, heated shingle particles, and liquid asphalt are thoroughly mixed to form an asphalt paving composition.

J. McGraw et al., “Recycled Shingles in Hot Mix Asphalt,” tinyurl.com/mobbf3e (unknown date) discloses the use of recycled tear off shingles in HMA. Asphalt shingles are recycled in a dry blending process, in which RAS is used as a source of aggregate.

While a number of states (e.g., Minnesota and Missouri) have supported the use of RAS in asphalt paving, the performance of RAS from the dry blending process has been mixed. The degree to which RAS and virgin asphalt actually blend is uncertain in many instances.

R. Mallick et al., “Evaluation of Use of Manufactured Waste Asphalt Shingles in Hot Mix Asphalt,” Chelsea Center for Recycling and Economic Development Technical Report #26, tinyurl.com/lutjplj (2000) reported that HMA incorporating waste shingles had volumetric and low temperature properties not significantly different from that of conventional HMA. The recycled shingles were blended with aggregates prior to mixing with asphalt binder. (See p. 3.)

D. Oldham et al., “Investigating the Rejuvenating Effect of Bio-Binder on Recycled Asphalt Shingles,” paper presented at Transportation Research Board 93rd Annual Meeting (Washington, D.C. Jan. 12-16, 2014) reports on the effect of a blended percentage of recycled asphalt shingles (RAS) on the performance and workability of asphalt binders designed with and without a percentage of “bio-binder” made from processed swine manure.

The recycling of asphalt shingles in HMA could be valuable for technical, economical, and environmental reasons. Reducing the amount of virgin asphalt binder that needs to be added to HMA mixtures would provide significant benefits to the asphalt industry and highway agencies. However, the resulting products must have competitive mechanical properties and performance characteristics. There is an unfilled need for improved methods for incorporating RAS into HMA, so that the resulting product is well-suited for use in highway construction, as well as in other applications where asphalt is employed.

### DISCLOSURE OF THE INVENTION

We have discovered a new method for recycling waste asphalt shingles and incorporating them into hot mix asphalt for use in applications such as asphalt pavement construction. Unlike previous methods, the asphalt from ground shingles is mixed with and becomes an integral component of the asphalt binder, instead of acting primarily as part of the aggregate. The asphalt content of the shingles mixes with heated asphalt binder to produce a single asphalt phase, and the asphalt from the shingles acts as asphalt in the final composite.

Ground asphalt waste material is mixed with virgin asphalt binder. The asphalt waste material is ground to an ultrafine powder. The virgin binder is heated, e.g., to a temperature of approximately 180° C. Then the ground asphalt waste material is blended into the virgin binder at a rate of about 10% to about 40% by weight of the binder at a blending temperature ranging from about 180° C. to about 200° C. It stays heated and is mixed with continuous mechanical agitation to blend the melted asphalt from the two sources—asphalt binder and RAS—e.g., using a mechanical shear mixer at about 1500 rpm for about 30 minutes. Immediately prior to HMA production, it is preferred to maintain constant agitation and a minimum temperature of about 100° C. or greater to inhibit settling of fiber and mineral granules from the ground RAS material. For example, agitation systems such as those currently used for crumb-rubber modified asphalt may also be used to provide agitation for the novel wet process. The resulting modified asphalt binder is mixed with aggregate to produce hot mix asphalt, which may then be used in road construction, or in other types of asphalt-based products employing HMA.

In prior methods, the asphalt binder has typically been heated only to about 140-150° C., just hot enough to make it sufficiently liquid, and it has typically not been agitated. By contrast, in the present invention the asphalt binder is heated to a sufficient temperature (typically 180-200° C.), and the heated asphalt binder is sufficiently agitated with the admixed ground RAS to make a product having a single asphalt phase, in which asphalt from the RAS and asphalt from the asphalt binder are thoroughly mixed so that asphalt from the RAS acts as asphalt binder in the finished product, and not just as a part of the aggregate. In prior methods, the RAS has typically been ground to ˜5 mm to 2 cm, which is an adequate size for aggregate. In the present method, although there is no precise upper bound on the size of the ground RAS, it is preferred to grind it small to increase the surface area, to enhance blending between RAS asphalt and asphalt binder, and to reduce the mixing time. For example, in prototype experiments the RAS has been ground as small as 75 μm. Although a smaller size enhances the blending, it also makes the grinding step more expensive. There is a tradeoff between finer particles (faster blending) and the cost of grinding. The optimum size for the ground RAS particles will primarily be a function of this economic tradeoff. Ideally, the size of the particles should be such that 50% of the RAS comprises particles smaller than 75 μm. However, coarser grindings may be used to reduce the cost of the grinding step. For convenience, the ground shingles may be packaged and delivered to the HMA plant convenient containers or packaging, e.g., in bags similar to those used for farm fertilizers.

The novel process provides better control of the chemical and physical properties of the modified asphalt binder. Because the RAS is ground to small particle size and is mixed with heated asphalt binder, the asphalt from the RAS commingles with the asphalt from the virgin binder. Unlike previous uses of RAS, in the novel process the asphalt from the RAS particles contributes to the asphalt binder of the finished HMA product, and does not just become another source of aggregate. This property allows control of the final performance grade of the modified binder. Additionally, optimal shingle content actually improves the high temperature performance of the modified binder as compared to unmodified binder, without adversely affecting low temperature performance. The fibrous shingle base (organic or fiberglass) also contains fibers that can enhance the performance of asphalt mixtures. The fibers mix better with the composite than has been the case in prior methods.

As compared to prior methods for recycling RAS, the percentage of asphalt shingles used in the final HMA may be higher with the novel process. Optionally, the RAS can act not only as a partial replacement for virgin asphalt binder, but also as a binder extender due to the presence of fillers, rubber, or fibers in the processed RAS material. In the case of partial replacement, the amount of virgin asphalt binder needed in the mix is reduced, since the asphalt in the RAS will complement the asphalt in the mix and will function as a binding agent in the mix. In the case of binder extender, the asphalt in RAS increases the volume occupied by the binder, and therefore allows a reduction in the amount of asphalt needed in the mix. Our research found that in different experiments wet processing reduced virgin binder content by ˜7-8%; while dry processing reduced it by 9.4%. Thus the novel wet process can achieve a comparable level of replacement for the binder as compared to the dry process, while providing advantages including better quality control, improved commingling of virgin and recycled materials, and reduced maintenance costs. See Table 1, which describes the properties of various mix designs used in our experiments.

TABLE 1
Mix Design of Various Asphalt Mixtures

Mix ID

| Parameter | 70CO | 70DT | 70WI | 70WT |
|---|---|---|---|---|
| % Gₘₘ at Nᵢₙᵢ | 88.8 | 88.9 | 88.9 | 88.2 |
| % Gₘₘ at Nₘₐₓ | 97.0 | 96.9 | 97.1 | 96.9 |
| Air Voids % | 4.0 | 4.0 | 4.0 | 4.0 |
| VMA % | 13.3 | 14.0 | 14.0 | 13.5 |
| VFA % | 70 | 71 | 73 | 78 |
| Total % AC | 5.3 | 5.3 | 5.0 | 5.2 |
| % AC (Virgin) | 5.3 | 4.8 | 4.6 | 4.8 |

Gradation - Sieve Size (mm)

| | | | | |
|---|---|---|---|---|
| 19.0 | 100 | 100 | 100 | 100 |
| 12.5 | 97 | 97 | 97 | 97 |
| 9.5 | 85 | 86 | 85 | 85 |
| 4.75 | 63 | 64 | 63 | 63 |
| 2.36 | 44 | 45 | 44 | 44 |
| 1.18 | 32 | 32 | 31 | 32 |
| 0.600 | 24 | 24 | 23 | 24 |
| 0.300 | 17 | 17 | 17 | 17 |
| 0.150 | 8 | 9 | 8 | 8 |
| 0.075 | 5.3 | 5.2 | 5.4 | 5.4 |
| Binder Replacement | N/A | 9.4 | 8.0 | 7.7 |
| (%) | | | | |

TABLE 2
Comparison of Conventional Dry Process to the Novel Wet Process

| Conventional Dry Process | Novel Wet Process |
|---|---|
| RAS is typically added to the aggregate | RAS is blended with the virgin asphalt binder |
| source, similar to the manner in which | under heat and agitation, to commingle asphalt |
| reclaimed asphalt pavement is sometimes used. | from the RAS with that in the virgin binder, |
| Commingling of virgin and aged asphalt, if | before the blend is mixed with aggregate. |
| any, is incomplete. | |
| Typically requires an additional bin at the plant | Requires apparatus to facilitate mixing of |
| to hold ground RAS | ground RAS with asphalt binder, e.g., an |
| | agitation tank |
| RAS + virgin binder performance grade is | Performance grade can be measured prior to |
| unknown since the blending occurs during | production of the binder since the blending |
| aggregate + asphalt mixing (i.e., the blend is | occurs prior to introducing the aggregate. |
| not recoverable). | |
| Overestimating the level of blending can result | Blending is improved by heating and agitation, |
| in a dry mixture as a portion of the asphalt in | which stimulates physical and chemical |
| RAS acts as a black rock and does not | interaction between virgin asphalt binder and |
| effectively contribute to the mix properties. | recycled asphalt shingle. |

The invention is particularly suited for, although it is not limited to, recycling asphalt roofing waste—particularly asphalt roofing shingles and shingle manufacturing factory waste. The shingles may be organic or fiberglass, although the invention is not limited to any particular type of shingle. The invention provides a simple, straightforward process for recycling asphalt waste materials, to produce a product with predictable characteristics that is economical and environmentally friendly. Asphalt binders are generally designed to satisfy different locales' specifications, based largely on local temperature ranges—e.g., southern roads typically endure hotter temperatures in the summer, while northern roads endure colder temperatures in the winter. The novel process allows control of the binder's performance grade to accommodate such variation.

### BRIEF DESCRIPTION OF THE DRAWINGS

FIG. 1 depicts the fracture resistance potential of asphalt materials using a semi-circular bending test.

FIGS. 2A and 2B depict the HP-GPC chromatograms of Base, RAS-Modified, and Shingle Binders.

FIGS. 3A and 3B depict the fractional distributions of low and high molecular weight binder fractions, as determined by HP-GPC.

FIGS. 4A and 4B depict levels of separation of binders in a cigar tube test.

FIG. 5 depicts final rut depths of asphalt mixtures in a loaded wheel-tracking test.

FIG. 6 depicts critical strain energies for asphalt mixtures in a semi-circular bending test.

FIG. 7 depicts critical temperatures for asphalt mixtures in a Thermal Stress Restrained Specimen Test.

### METHODS

### Example 1

### Abbreviations

TABLE 3
Abbreviations

| | |
|---|---|
| AASHTO | American Association of State Highways and |
| | Transportation Officials, Washington, DC |
| ANOVA | Analysis of Variance |
| ASTM | American Society for Testing and Materials |
| CLSM | Confocal laser-scanning microscopy |
| HMA | Hot mix asphalt |
| HMW | High molecular weight |
| HP-GPC | High-pressure gel permeation chromatography |
| LMW | Low molecular weight |
| LWT | Hamburg loaded wheel-tracking test |
| MAME | Manufactured shingles from Maine used in some of the tests |
| PAV | Pressure aging vessel |
| PG | Performance grade |
| RAS | Recycled asphalt shingles |
| RTFO | Rolling thin film oven |
| SCB | Semi-circular bending test |
| SHIN | Virgin air-blown binder used in the manufacturing of shingles |
| TMO | Tear off shingles from Missouri used in some of the tests |
| TSRST | Thermal Stress Restrained Specimen Test |

### Example 2

### Recyclable Materials

RAS input streams from construction and demolition processing plants are generally collected over a large geographic area (e.g., statewide), thereby averaging the variation among different types of RAS, and normally providing a relatively consistent product. For the asphalt binder experiments, RAS was taken either from tear-off shingles collected in Missouri (referred to as TMO), or from manufactured shingles collected in Maine (referred to as MAME). For the asphalt mixture experiments, RAS was obtained from Texas and Illinois.

The recycled asphalt waste material was ground into ultrafine particles at room temperature using a Pulva-Sizer® hammer mill operated at high rotational speed, approximately 9,600 rpm. The particle size distribution of the processed RAS was characterized by laser diffraction. The processed RAS samples were analyzed using a Beckman Coulter particle size analyzer (LS13 320) operated in wet mode. Approximately 80% of the processed RAS by weight passed through a 200 mesh screen. Approximately 1 g of ground RAS was wetted with 26 drops of an aqueous glycerol solution, followed by 20 sec of bath sonication. Results of the particle size analysis by laser diffraction are presented in Table 4 for the ground TMO and MAME materials. The mean particle sizes were 85.5 μm for TMO and 201.0 μm for MAME, with a standard deviation approximately equal to the mean of the distribution, indicating that the particle size distribution was heavily weighted far from the mean.

TABLE 4
Summary of Particle Size Analysis by Laser Diffraction

| RAS Type | Mean (μm) | Median (μm) | SD (μm) |
|---|---|---|---|
| TMO | 85.5 | 60.3 | 119.0 |
| MAME | 201.0 | 133.0 | 196.0 |

### Example 3

### Materials for Binder Experiments

The Performance Grade (PG) of asphalt cement is based on two factors: traffic levels and pavement temperature. The PG grading system gives two numbers, the first of which represents the high pavement temperature and the second of which represents the low pavement temperature (both measured in degrees Celsius). For example, PG 64-22 denotes a high pavement temperature of 64° C., and a low pavement temperature of −22° C. By convention, these temperatures are given in 6-degree increments. The high temperature pertains to the effects of rutting, and the low temperature pertains relates to cold temperature and fatigue cracking.

Prototype testing used two types of virgin asphalt binders, one classified as PG 64-22 and one classified as PG 52-28 according to Superpave specifications.

Asphalt binder blends containing virgin binder and the ultrafine RAS were prepared at proportions of 10%, 20%, and 40% RAS by weight of the binder. 500 g of virgin binder was first heated to a temperature of approximately 180° C. Then the ground, ultrafine recycled asphalt shingle waste powder was added to the heated virgin binder. The two components were blended at approximately 180° C. using a mechanical shear mixer operating at 1500 rpm for 30 minutes.

In addition to the virgin and modified asphalt binders, a virgin air-blown binder that is commonly used in the manufacturing of shingles was also tested (referred to as SHIN). Test materials used in these experiments are listed in Table 5.

TABLE 5
Materials used in binder experiments

| | Shingle | | |
|---|---|---|---|
| | Content | | |
| Binder | (%) | Shingle Source | Description |
| 52-28 | 0 | N/A | Conventional binder with |
| | | | no shingle |
| MAME1528 | 10 | Manufactured | 52-28 binder with 10% shingle |
| MAME2528 | 20 | Manufactured | 52-28 binder with 20% shingle |
| MAME4528 | 40 | Manufactured | 52-28 binder with 40% shingle |
| TMO1528 | 10 | Tear-off | 52-28 binder with 10% shingle |
| TMO2528 | 20 | Tear-off | 52-28 binder with 20% shingle |
| TMO4528 | 40 | Tear-off | 52-28 binder with 40% shingle |
| 64-22 | 0 | N/A | Conventional binder with |
| | | | no shingle |
| MAME1622 | 10 | Manufactured | 64-22 binder with 10% shingle |
| MAME2622 | 20 | Manufactured | 64-22 binder with 20% shingle |
| TMO1622 | 10 | Tear-off | 64-22 binder with 10% shingle |
| TMO2622 | 20 | Tear-off | 64-22 binder with 20% shingle |
| TMO4622 | 40 | Tear-off | 64-22 binder with 40% shingle |
| SHIN | 0 | N/A | Conventional air-blown binder |
| | | | used in shingle manufacturing |
| EXT TMO | 0 | Tear-off | Extracted binder from ground |
| | | | TMO shingle |
| EXT MAME | 0 | Manufactured | Extracted binder from |
| | | | ground MAME shingle |

### Example 4

### Tests Made in the Binder Experiments

The binders in Table 5 were tested to determine the effects of RAS modification on rheological properties, molecular and fractional compositions, and binder compatibility and stability. The tests were: rheological and Superpave binder testing, confocal laser-scanning microscopy (CLSM), cigar tube tests, and high-pressure gel permeation chromatography (HP-GPC).

### Example 5

### Rheological Tests

The asphalt binders were characterized using fundamental rheological tests (viz., dynamic shear rheometry, rotational viscosity, and bending beam rheometry). We also compared the performance grade of the RAS-modified binder to the unmodified binders.

Tests were conducted according to AASHTO specifications:

AASHTO M 320-09. (2009b). “Standard specification for performance-graded asphalt binder.”
AASHTO T 313-09. (2009a). “Standard method of test for determining the flexural creep stiffness of asphalt binder using the bending beam rheometer (BBR).”
AASHTO T 315-10. (2010a). “Standard method of test for determining the rheological properties of asphalt binder using a dynamic shear rheometer (DSR).”
AASHTO T 316-10. (2010b). “Standard method of test for viscosity determination of asphalt binder using rotational viscometer.”

### Example 6

### Confocal Laser-Scanning Microscopy

The asphalt binders' microstructure was examined by confocal laser scanning microscopy (CLSM) in fluorescence mode. This method was chosen both because it is able to identify a variety of different components in the asphalt binder, including wax crystals, and also because the simple method of sample preparation does not affect the microscopic structure of the binder. Under CLSM fluorescence, wax crystals in the binder appear as light-colored flecks. The concentration and morphology of wax particles is believed to affect binder performance. Based on the results of our research, it appears that a higher concentration of wax crystals causes the binder to be stiffer and more brittle than a binder with a lower concentration of wax crystals. Observations were made with a Leica TCS SP2 microscope. Samples were irradiated at 488 nm, and fluorescence was observed in the range 500-550 nm. All images were captured as two-dimensional images in 1024×1024 bit TIFF format.

Microscopic samples were prepared by heating the binders to a fluid state while stirring vigorously. Then a small drop was poured onto a glass slide. To ensure a thin, uniform sample depth, a cover slip was placed on top of the drop of binder while it was still in a fluid state. Then the glass slide was placed on a heated plate at 120° C. and left for 15 minutes until the drop flowed under the weight of the glass to cover the entire width of the slip.

### Example 7

### Cigar Tube Test

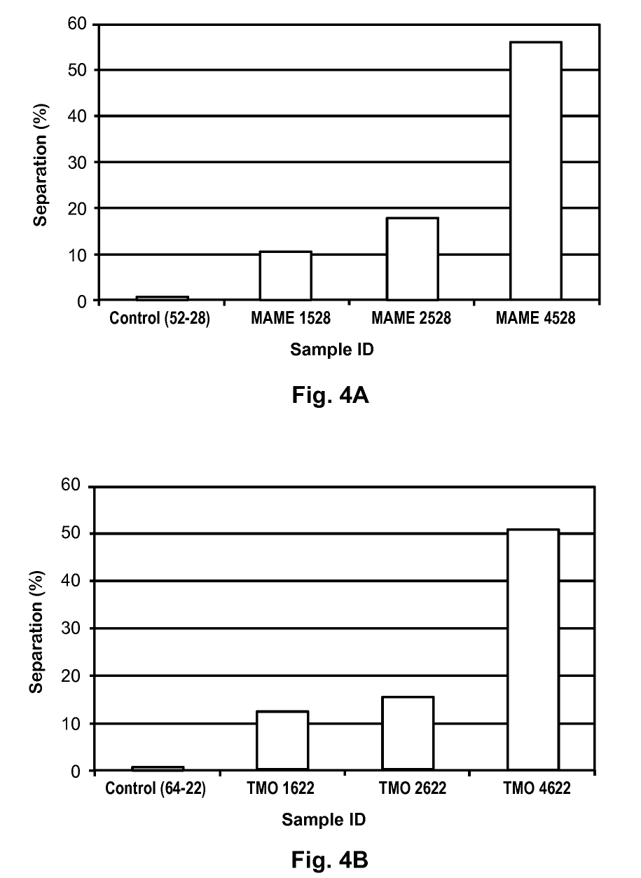

The compatibility and stability of the asphalt binders were evaluated using the cigar tube test per ASTM D 7173-05. (2005). “Standard practice for determining the separation tendency of polymer from polymer modified asphalt.” This test is a laboratory assay used to estimate the separation tendency of polymer-modified asphalt binder. In this test, 50 g of each sample of asphalt binder was poured into a sealed aluminum tube that was kept in a vertical position for 48 hours at a temperature of 163±5° C. At the end of the conditioning period, the top and bottom parts of the tube were separated and tested using a dynamic shear rheometer. The stability and level of separation of the binders were thus determined. See Jensen and Abdelrahman (2006). “Crumb Rubber in Performance Graded Asphalt Binder.” Report No. SPR-01 (05) P585, Lincoln, Nebr., which describes the method in greater detail, and which recommends that the measured level of separation not exceed 10-15% for a crumb rubber modifier binder. As shown in FIGS. 4A and 4B, at an RAS content about 40%, the stability and workability of the blend can decline as greater separation occurs.

$$Separation = \frac{{( {G}^{*} / sin δ )}_{max} - {( {G}^{*} / sin δ )}_{avg}}{{( {G}^{*} / sin δ )}_{avg}} \times 100. \qquad Equation 1$$

where G*=complex shear modulus; δ=phase angle; (G*/sin δ)ₘₐₓ=higher value of either the top or the bottom portion of the tube; (G*/sin δ)_{avg}=average value of the top and the bottom portions of the tube. Based on these results, an RAS content of about 25% or less is preferred for most applications, to reduce the amount of separation.

### Example 8

### High-Pressure Gel Permeation Chromatography

An Agilent 1100 gel permeation chromatograph with an auto injector and a Hitachi differential refractive index detector were used to conduct HP-GPC on the several asphalt binders. The components of the asphalt were separated on three columns connected in series: the first had a pore size of 0.5 μm, the second had a pore size of 1 μm angstrom, and the third was a mixed bed with polymer beads having a range of pore sizes. The column set was calibrated with narrow molecular weight polystyrene standards, 1% by weight in tetrahydrofuran. The elution volume observed for the polystyrene standards was used to prepare a molecular weight calibration curve. All asphalt binder samples were prepared at a concentration of 3% by weight in tetrahydrofuran, injected through a 0.45-μm filter into 150-μL vials, and inserted in the automatic injector. Samples were eluted with tetrahydrofuran at 1 mL/min at room temperature, and the concentration in the eluent was recorded with a differential refractometer.

The molecular weight distributions were allocated between a high molecular weight fraction (HMW) and a low molecular weight fraction (LMW), with the cutoff between the two defined as 3000 dalton. The HP-GPC curves were integrated, and the areas were normalized over the total area of the chromatogram. The expected error in the measured molecular weight fractions was approximately 0.2% or less. Two replicates were measured for each binder sample, and average values were used in the analyses.

### Example 9

### Materials for Mixture Experiments

Two mixtures, 64CO and 70CO were used as controls in the mixture experiments. The 64CO mixture was prepared with a virgin unmodified PG 64-22 asphalt binder, and the 70CO mixture was prepared with a virgin polymer-modified PG 70-22 asphalt binder. Other mixtures contained RAS at 5% from Texas (70D5T), RAS at 20% from Texas (70W20T), or RAS at 20% from Illinois (70W20I). The 70D5T was dry-mixed in the conventional manner; while 70W20T and 70W20I were wet-mixed in accordance with the present invention. Table 6 summarizes the tests. Triplicate specimens were used in each test, except that two specimens were used in the LWT test. All specimens were compacted to an air void level of 7±1%. Test results had a coefficient of variation that was less than 15% in each case.

TABLE 6
Materials used in mixture experiments

Mixture Variables

| Mixture | RAS | | LWT | TSRST | SCB |
|---|---|---|---|---|---|
| ID | Content | Process | Unaged | Aged | Aged |
| 64CO | 0 | N/A | 2 | N/A | 3 |
| 70CO | 0 | N/A | 2 | 3 | 3 |
| 70D5T | 5%* | Dry | 2 | 3 | 3 |
| 70W20I | 20%** | Wet | 2 | 3 | 3 |
| 70W20T | 20%** | Wet | 2 | N/A | 3 |

*by total weight of mixture;
**by total weight of binder;
N/A = Not Available (test not conducted)

### Example 10

### Tests for Mixture Experiments

Laboratory tests evaluated rutting performance, fracture resistance, and thermal cracking resistance of the asphalt mixtures using the Hamburg loaded wheel-tracking (LWT) test, semi-circular bending (SCB) test, and Thermal Stress Restrained Specimen Test (TSRST).

### Example 11

### Loaded Wheel-Tracking Test

Rutting performance of each mixture was assessed using a Hamburg-type loaded wheel tester manufactured by PMW, Inc. of Salina, Kans. This test was conducted in accordance with AASHTO T 324. (2007). “Hamburg wheel-track testing of compacted hot mix asphalt (HMA).” This test induces damage by rolling a 703 N (158 lb.) steel wheel across the surface of a slab submerged in 50° C. water for 20,000 passes at 56 passes a minute. The rut depth after 20,000 cycles was measured. The maximum allowable rut depth was taken as 6 mm.

### Example 12

### Semi-Circular Bending Test

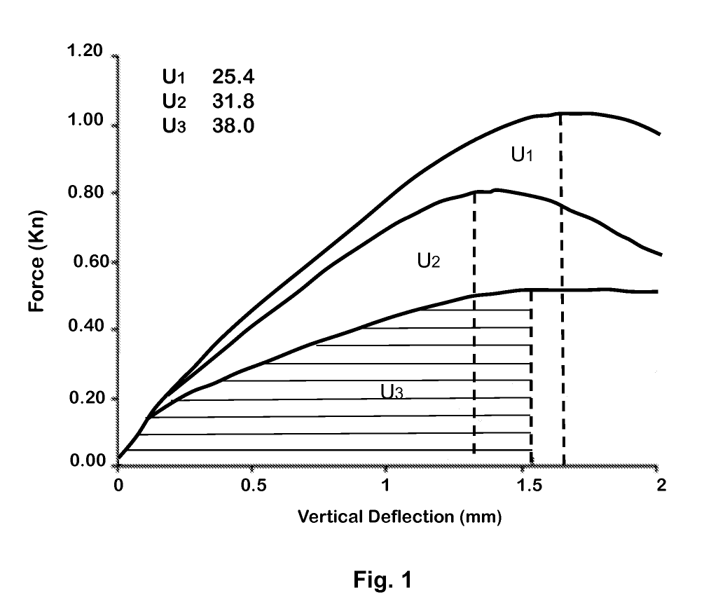

Fracture resistance potential was assessed using the semi-circular bending test of Wu et al. (2005). “Fracture Resistance Characterization of Superpave Mixtures Using the Semi-Circular Bending Test.” Journal of ASTM International, Vol. 2, No. 3. This test characterizes the fracture resistance of HMA mixtures based on fracture mechanics principals and the critical strain energy release rate, also called the critical value of the J-integral, or J_{c}. FIG. 1 presents representative three-point bend load configurations and test result outputs from the SCB test. U1, U2, and U3 are the strain energy values measured at three notch depths (i.e., 25.4, 31.8, and 38.0 mm).

To determine the critical value of the J-integral (J_{c}), semi-circular specimens with at least two different notch depths were tested for each mixture. Three notch depths (25.4 mm, 31.8 mm, and 38 mm) were selected to have an a/r_{d} ratio (the notch depth to the radius of the specimen) between 0.5 and 0.75. Test temperature was 25° C. The semi-circular specimen was loaded monotonically under a constant crosshead deformation rate of 0.5 mm/min in a three-point bending load configuration until fracture failure occurred. The load and deformation were continuously recorded, and the critical value of the J-integral (J_{c}) was determined from the following equation (Elseifi et al. (2012). “Modeling and Evaluation of the Semi-Circular Bending Test for Intermediate Temperature Cracking of Asphalt Mixtures.” Road Materials and Pavement Design, Vol. 13, No. 1, 124-139):

$${J}_{c} = ( \frac{{U}_{1}}{{b}_{1}} - \frac{{U}_{2}}{{b}_{2}} ) \frac{1}{{a}_{2} - {a}_{1}} . \qquad Equation 2$$

where b=sample thickness (m); a=notch depth (m); and U=strain energy to failure (kJ).

### Example 13

### Thermal Stress Restrained Specimen Test

Low-temperature cracking performance was assessed in a thermal stress restrained specimen test (TSRST). Changes in the binder's glass transition temperature were observed to determine the effects of mixture composition on low-temperature cracking. This test was conducted according to the method of AASHTO TP 10-93. (1993). “Standard test method for Thermal Stress Restrained Specimen Tensile Strength (TSRST).” Triplicate specimens 50 mm thick×50 mm wide×254 mm long were used. Each specimen was glued to an aluminum plate at each end. The test device cooled the beam specimen while restraining it from contracting. As the temperature dropped, thermal stresses built up until the specimen fractured.

### Results

### Example 14

### Rheological and Superpave Binder Results

Using RAS as a binder modifier increased the viscosity, stiffened the binder at high temperatures, and reduced elongation properties at low temperatures. The novel wet mixing process allowed better control of the performance grade of the modified binder than did conventional dry processes. In preliminary experiments, the best results were seen when unheated ground RAS was added to heated virgin binder at a fraction of 20% or less.

Tables 7 and 8 present the measured rheological properties of both RAS-modified and unmodified binders. The final PG grades were determined from laboratory tests with a rotational viscometer, dynamic shear rheometer, and bending beam rheometer. Results are given for thirteen types of binders: PG 64-22 conventional, PG 64-22+10% or 20% MAME, PG 64-22+10% or 20% TMO, SHIN, PG 52-28 conventional, PG 52-28+10%, 20%, or 40% MAME, and PG 52-28+10%, 20%, or 40% TMO.

SHIN that is used in shingle manufacturing has stiff characteristics and low temperature elongation properties. In fact, SHIN is ranked by the Superpave binder specification system as PG 100, and it does not pass the m-value criterion at low temperature, even when tested at 0° C.

The results in Tables 7 and 8 indicate that the novel RAS modification improved, or at least did not adversely affect, the high temperature performance of the binder, while it reduced the elongation characteristics of the binder at low temperature. However, because test specifications change in the Superpave PG system when the high temperature grade is shifted (e.g., from 52 to 58° C.), an optimum shingle content can be chosen to improve the high temperature grade without adversely affecting the low temperature grade of the binder (e.g., TMO2528 and MAME2528 with a final PG grade of 58-28). The novel process can be beneficially used to control the final PG grade of the binder.

TABLE 7
Results of Superpave PG Testing (PG 64-22)

| | | | | | | | | |
|---|---|---|---|---|---|---|---|---|
| | | | | PG 64 | PG 64 | PG 64 | PG 64 | |
| | | | | +10% | +20% | +10% | +20% | |
| | | Test | | MAME | MAME | TMO | TMO | |
| Binder Testing | Spec | Temp | PG 64-22 | MAME1622 | MAME2622 | TMO1622 | TMO2622 | SHIN |

Test on Original Binder

| | | | | | | | | |
|---|---|---|---|---|---|---|---|---|
| Dynamic Shear, | 1.00⁺ | 64° C. | 2.16 | 2.66 | 2.7 | 3.06 | 4.165 | 1.08 (100° C.) |
| G*/Sin(δ), | | | | | | | | |
| (kPa), | 1.00⁺ | 70° C. | 0.993 | 1.28 | 1.23 | 1.38 | 1.91 | — |
| AASHTO T315 | | | | | | | | |
| Rotational | 3.0⁻ | 135° C. | 0.48 | 0.53 | 0.67 | 0.69 | 0.70 | 3.74 |
| Viscosity (Pa · s), | | | | | | | | |
| AASHTO T316 | | | | | | | | |

Tests on RTFO (rolling thin film oven)

| | | | | | | | | |
|---|---|---|---|---|---|---|---|---|
| Dynamic Shear, | 2.20⁺ | 64° C. | 4.37 | 5.15 | 7.07 | 11.2 | 7.42 | 2.49 (100° C.) |
| G*/Sin(δ), | | | | | | | | |
| (kPa), AASHTO | 2.20⁺ | 70° C. | 1.96 | 2.29 | 3.11 | 4.08 | 3.35 | — |
| T315 | | | | | | | | |

Tests on RTFO+ PAV (pressure aging vessel)

| | | | | | | | | |
|---|---|---|---|---|---|---|---|---|
| Dynamic Shear, | 5000⁻ | 28° C. | 2940 | 4050 | 3910 | 3925 | 3350 | 4185 (25° C.) |
| G*Sin(δ), (kPa), | | | | | | | | 5185 (22° C.) |
| AASHTO T315 | | | | | | | | |
| BBR Creep | 300⁻ | −6° C. | 88 | 90 | 108 | 89 | 111 | 43 (0° C.) |
| Stiffness, | | −12° C. | 189 | 209 | 227 | 179 | 195 | 66 (−6°) |
| (MPa), | | | | | | | | |
| AASHTO T313 | | | | | | | | |
| Bending Beam | 0.300⁺ | −6° C. | 0.364 | 0.356 | 0.332 | 0.344 | 0.365 | 0.290 (0° C.) |
| m-value | | −12° C. | 0.322 | 0.285 | 0.287 | 0.278 | 0.298 | 0.261 (−6° C.) |
| AASHTO T313 | | | | | | | | |

| | | | | | | |
|---|---|---|---|---|---|---|
| Actual PG Grading | PG | PG | PG | PG | PG | PG 100 |
| | 64-22 | 70-16 | 70-16 | 70-16 | 70-16 | |

TABLE 8
Results of Superpave PG Testing (PG 52-28)

| | | | | | | | PG 52 | PG 52 | PG 52 |
|---|---|---|---|---|---|---|---|---|---|
| | | | | PG 52 +10% | PG 52 +20% | PG 52 +40% | +10% | +20% | +40% |
| Binder | | Test | | MAME | MAME | MAME | TMO | TMO | TMO |
| Testing | Spec | Temp | PG 52-28 | MAME1528 | MAME2528 | MAME4528 | TMO1528 | TMO2528 | TMO4528 |
| | | Test on Original Binder | | | | | | | |
| Dynamic | 1.00⁺ | 58° C. | 1.02 | 1.08 | 1.29 | 2.48 | 1.07 | 1.52 | 3.49 |
| Shear, | | | | | | | | | |
| G*/Sin(δ), | | | | | | | | | |
| (kPa), | | | | | | | | | |
| AASHTO | | | | | | | | | |
| T315 | | | | | | | | | |
| Rotational | 3.0⁻ | 135° C. | 0.213 | 0.233 | 0.296 | 0.444 | 0.238 | 0.306 | 0.341 |
| Viscosity | | | | | | | | | |
| (Pa · s), | | | | | | | | | |
| AASHTO | | | | | | | | | |
| T316 | | | | | | | | | |
| | | Tests on RTFO | | | | | | | |
| Dynamic | 2.20⁺ | 52° C. | 4.07 | 4.59 | 5.82 | — | 4.33 | 7.44 | — |
| Shear, | | 58° C. | 1.81 | 1.98 | 2.43 | 3.84 | 1.94 | 3.08 | 3.86 |
| G*/Sin(δ), | | | | | | | | | |
| (kPa), | | | | | | | | | |
| AASHTO | | | | | | | | | |
| T315 | | | | | | | | | |
| | | Tests on (RTFO+ PAV) | | | | | | | |
| Dynamic | 5000⁻ | 16° C. | 4920 | 5345 | 5595 | 5020 (22° C.) | 6070 | 6150 | 4780 |
| Shear, | | | | | | | | | (22° C.) |
| G*Sin(δ), | | 19° C. | 3135 | 3380 | 3585 | 3295 (25° C.) | 3870 | 4030 | 3150 |
| (kPa), | | | | | | | | | (25° C.) |
| AASHTO | | | | | | | | | |
| T315 | | | | | | | | | |
| BBR Creep | 300⁻ | −12° C. | 91 | 82 | 107 | 146 | 86 | 115 | 135 |
| Stiffness, | | −18° C. | 227 | 224 | 259 | 313 | 255 | 256 | 473 |
| (MPa), | | | | | | | | | |
| AASHTO | | | | | | | | | |
| T313 | | | | | | | | | |
| Bending Beam | 0.300⁺ | −12° C. | 0.405 | 0.394 | 0.382 | 0.347 | 0.383 | 0.379 | 0.341 |
| m-value | | | | | | | | | |
| AASHTO | | | | | | | | | |
| T313 | | | | | | | | | |
| | | −18° C. | 0.330 | 0.325 | 0.322 | 0.298 | 0.324 | 0.319 | 0.280 |

| | | | | | | | |
|---|---|---|---|---|---|---|---|
| Actual PG Grading | PG | PG | PG | PG | PG | PG | PG |
| | 52-28 | 52-22 | 58-28 | 58-16 | 52-22 | 58-28 | 58-22 |

### Example 15

### Confocal Laser-Scanning Microscopy Analysis

Microscopic samples were imaged by CLSM to detect the presence of wax crystals, and to study the effects of RAS on microscopic features of the binder. As noted in Example 6, the higher concentration of wax crystals may cause this binder to be stiffer and more brittle than at lower concentrations of wax molecules. Wax crystals generally in the range 4-8 μm were observed in the binder as light-colored flecks, in both SHIN and PG 52-28 binders. However, wax crystals were not detected in the RAS-modified binder, indicating that the RAS binder had almost entirely absorbed the wax crystals.

The microscopic images of both PG 52-28 and SHIN showed a continuous phase in which the wax crystals were dispersed and appeared as light-colored particles. The wax molecules generally had between about 20 to about 40 carbon atoms, and a melting point between about 60° C. and about 90° C. Both the size and concentration of the wax crystals were greater in SHIN than in PG 52-28. The concentration and shape of wax particles affects binder performance. The higher concentration of wax crystals in SHIN was likely the principal reason why the SHIN binder was stiffer and more brittle than the softer PG 52-28 binder.

The optical and fluorescence microscopic images of the binder prepared with PG 52-28+20% ground RAS shingles (MAME2528) showed that ground mineral particles were dispersed in the asphalt phase. However, the fluorescence microscopic images did not show the wax crystals that were seen in the SHIN and PG 52-28 binders. A reduction in wax crystal size below the detection limit of the CLSM could explain this observation. However, if such numerous small crystals were dispersed throughout the binder, one would expect to observe a background fluorescence. In fact, the components of the binder showed no appreciable fluorescence in the CLSM images. The same observation was made for the binder prepared with PG 52-28+40% ground RAS shingles (TMO4528). Absorption of the wax crystals by the RAS binder better explains the absence of fluorescence in the images of the modified binders than a hypothetical reduction in crystal size below the detection limit.

### Example 16

### High-Pressure Gel Permeation Chromatography Analysis

HP-GPC showed that the RAS-modified binders had higher levels of HMW components than the unmodified binders. The HMW content of the modified binders increased slightly at higher RAS levels, showing that the RAS-modified binder components were well mixed.

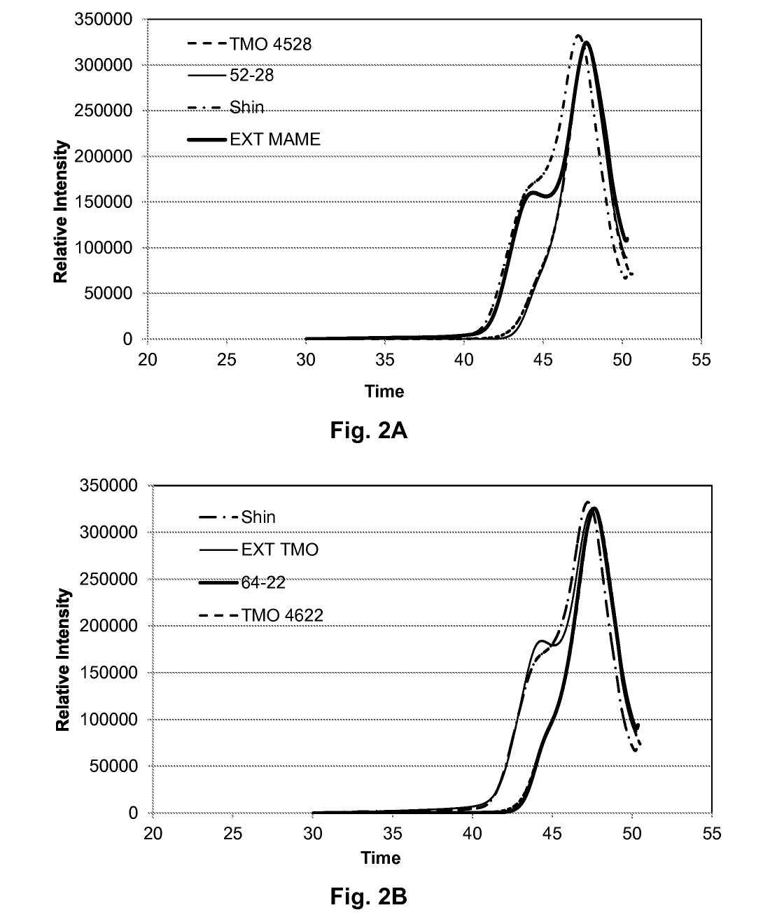

FIGS. 2A and 2B depict HP-GPC chromatograms for the virgin binders (PG 52-28 and 64-22), the RAS-modified binders (TMO4528 and TMO4622), the extracted binder for the RAS (EXT TMO and EXT MAME), and SHIN. The addition of RAS resulted in a slight shift in the molecular size distribution. This shift was not significant, as the 0.45 μm filter used in the experiment retained the majority of the fillers from the RAS materials. The significant shift in the chromatogram of the extracted binder and the SHIN indicated that the HMW fraction in these binders was greater than in the soft PG 52-28 and in the regular PG 64-22 binders.

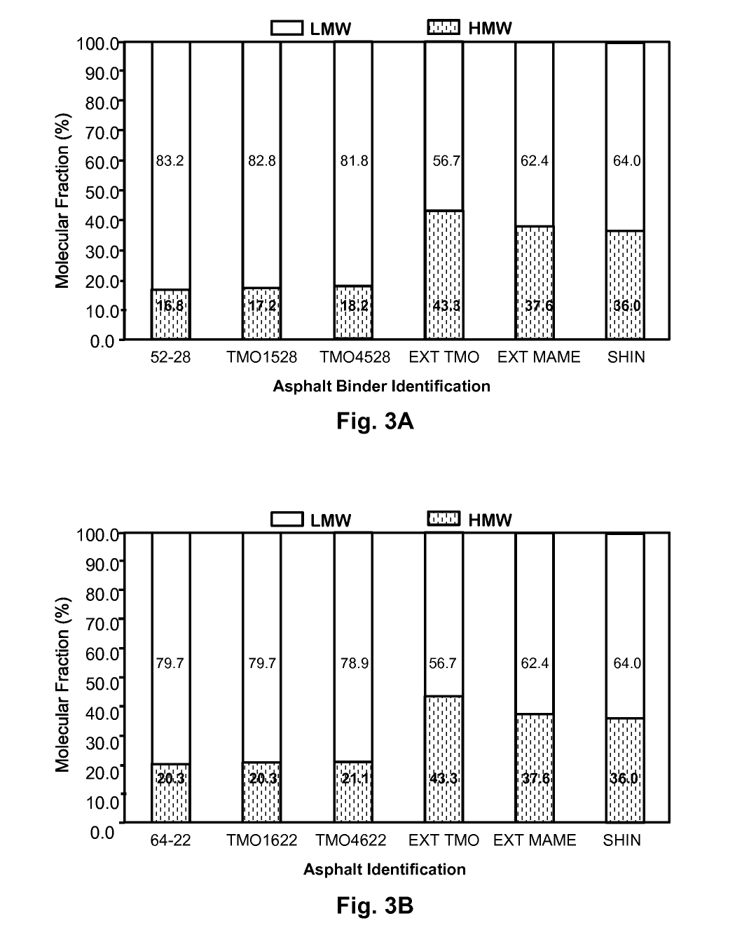

FIGS. 3A and 3B depict HP-GPC molecular size distribution results for the virgin binders, the RAS-modified binders, the extracted binder, and SHIN. These results show the effects of RAS modification on binder molecular composition.

Increasing a binder's LMW content (i.e., the fraction having M.W. below 3000) increased the elongation properties at intermediate and low temperatures. The extracted binder had a high HMW content, as expected. The RAS-modified binders had a slightly higher HMW content at higher percentages of RAS (PG 52-28 vs. TMO4528, and PG 64-22 vs. TMO4622). No increase in HMW was seen at low RAS percentage, because most of the ground RAS comprised mineral fiber, and mineral- and ceramic-coated granules.

### Example 17

### Cigar Tube Test Results

FIGS. 4A and 4B present the results of the cigar tube test for the unmodified binders as well as for the RAS-modified binders. Levels of separation were calculated as described above, using the dynamic shear rheometry results. When the level of RAS was about 20% or below, the degree of separation was under about 20%, which is considered acceptable. At an RAS content of 40%, the stability and workability of the binder declined because of the higher levels of separation, presumably because of the settling of mineral fillers from the RAS material. To minimize separation during storage, it is preferred to employ a tank with an agitator and a heater or super-heater. Prior to use in HMA production, to minimize aging of the binder, the blend is preferably maintained at a minimum temperature of about 100° C. under slow agitation. When HMA production begins, the blend should be heated to a temperature of about 180° C. to 200° C., preferably about 185° C., and then should be constantly agitated for approximately 30 minutes before use.

### Example 18

### Loaded Wheel-Tracking Test Results

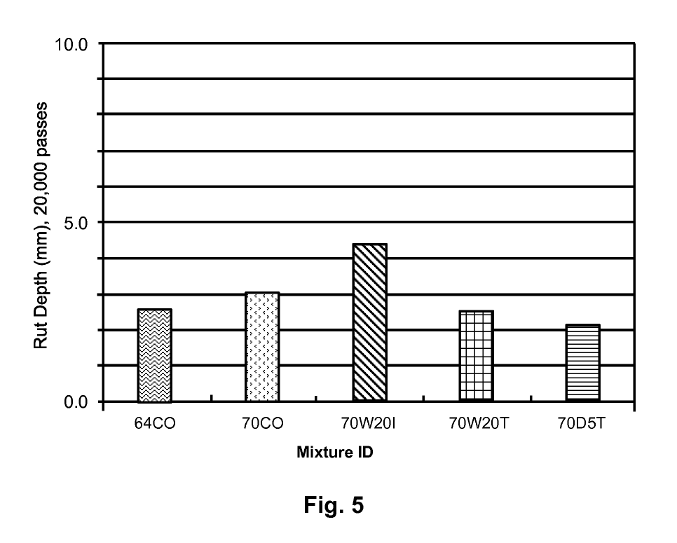

Rutting performance results for several asphalt mixtures are shown in FIG. 5, as measured by the Hamburg LWT. All mixtures showed a smaller rut depth than the 6.0 mm considered to be an allowable maximum after 20,000 passes. The RAS-modified binders were compared to the conventional counterpart mixture using Analysis of Variance (ANOVA) at 95% confidence level (α=0.05). The letters in FIG. 5 represent the resulting statistical groupings. The letter A was assigned to the mixtures with the best rut depth performances. Measurements with an “A” were significantly different from those with a “B.” The measurement indicated with an “A/B” was not significantly different from either the “A” group measurement or the “B” group measurement.

The LWT test results showed that the rutting performance of the RAS mixtures was satisfactory as compared to that for conventional mixtures.

### Example 19

### Semi-Circular Bending Test Results

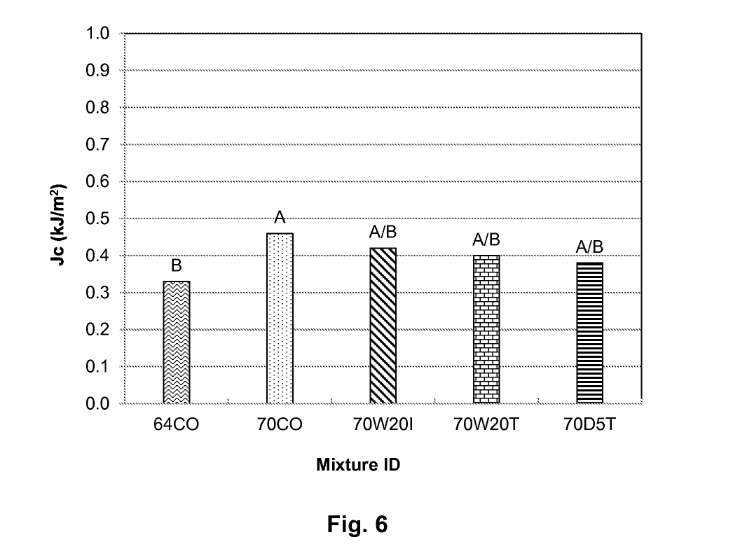

FIG. 6 depicts critical strain energy (J_{c}) data for the asphalt mixtures, indicating susceptibility to intermediate temperature cracking. High J_{c} values are desirable for fracture-resistance. A minimum threshold (J_{c}) of about 0.50 to about 0.65 kJ/m² is typically considered the failure criterion in this test. All mixtures were below this failure threshold. Adding RAS caused a slight decrease in the critical strain energy, presumably because the RAS-modified mixtures were stiffer than conventional HMA, and the RAS-modified mixtures had slightly lower binder content. Because the binder component of the mixture is primarily responsible for resistance to cracking resistance, the use of RAS did increase the brittleness of the binder at intermediate temperatures—but only slightly. Statistically, the cracking performance of the asphalt mixtures was not significantly affected by the use of RAS either through the dry or the wet processes. Letters “A” and “B” depict statistical groupings in a manner analogous to those in FIG. 5.

The asphalt binder that is chosen should not be too stiff. A binder that is too stiff may not mix as well with the asphalt component of the RAS. It is preferred that the performance grade (PG) of the binder should be about one grade lower than the PG for a “conventional” binder would be for a particular geographical region—i.e., a binder that is otherwise one that would be used in a particular geographical region, but that does not incorporate RAS or other recycled material.

### Example 20

### Thermal Stress Restrained Specimen Test Results

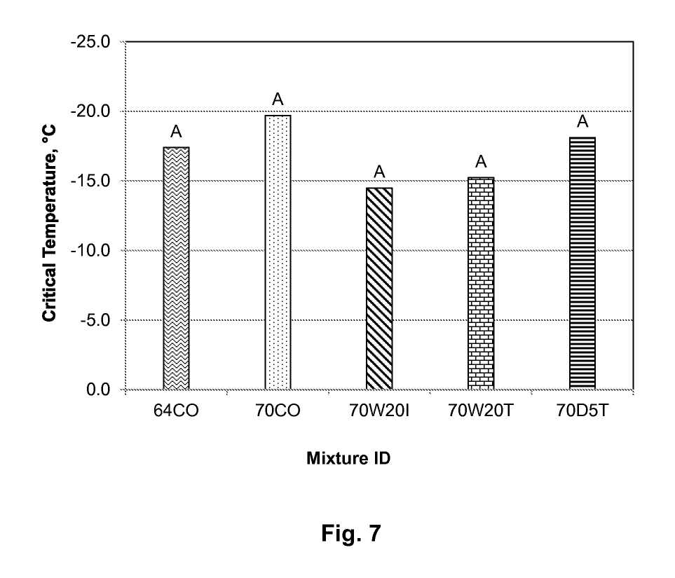

FIG. 7 depicts critical fracture temperatures for several asphalt mixtures as measured by TSRST. All mixtures tested had a critical fracture temperature above the low temperature grade of the binder (−22° C.). No statistically significant differences were observed from the addition of RAS.

### Example 21

### Miscellaneous

Unless otherwise clearly stated or implied by context, all composition percentages in the specification and claims should be understood to refer to percentage by mass. For example, a 1 kg sample of shingle that is “35% asphalt” contains 350 g of asphalt. Likewise, if a percentage of ground shingles is said to be particles smaller than a certain dimension, that percentage is by mass. For example, if “80%” of a 1 kg sample of ground shingles are particles smaller than 100 μm, that means that if the ground shingles were to be passed through a mesh having 100 μm holes, 800 g of the ground shingles would pass through the 100 μm holes. Where the Claims below refer to “shingles,” that term should be understood to encompass not only shingles, but also to include shingle manufacturing factory waste.

The complete disclosures of all references cited in the specification are hereby incorporated by reference in their entirety, as are the complete disclosures of priority application Ser. Nos. 61/772,734 and 61/614,546. Also incorporated by reference are the complete disclosures of M. Elseifi et al., “New Approach to Recycling Asphalt Shingles in Hot Mix Asphalt,” J. Mater. Civ. Eng., vol. 24, pp. 1403-1411 (2012); and M. Hassan et al., “Variability and Characteristics of Recycled Asphalt Shingles Sampled from Different Sources,” J. Mater. Civ. Eng., dx.doi.org/10.1061/(ASCE)MT.1943-5533.0000876 (2013); and M. Elseifi et al., nsfshingles.eng.lsu.edu (webpage first posted September 2011). In the event of an otherwise irresolvable conflict, however, the disclosure of the present specification shall control.

What is claimed:

1. A method for recycling asphalt shingles and incorporating the recycled shingles into a composite material suitable for use as an asphalt paving material; wherein the shingles comprise 10%-50% asphalt; said method comprising the steps of:
(a) grinding the shingles into particles, so that at least 50% of the ground shingles are particles smaller than 75 μm;
(b) heating an asphalt binder to 150-200° C., wherein said heating occurs in a container that initially contains neither shingles nor ground shingles nor aggregate;
(c) mixing the ground shingles and the heated asphalt binder at 185-200° C. for a sufficient time and with sufficient agitation to produce a single asphalt phase in the resulting mixture, in which the asphalt from the shingles and the asphalt from the asphalt binder are completely blended with one another; wherein no aggregate is present during said mixing step; and
(d) adding aggregate to the blended asphalt to produce a composite material, wherein the aggregate has such a particle size and wherein the aggregate is present in such a concentration that the composite material is suitable for use as an asphalt paving material.
(e)

2. The method of claim 1, wherein at least 50% of the ground shingles pass a 200 mesh.

3. The method of claim 1, wherein said heating step and said mixing step both occur at a temperature from about 170° C. to about 180° C.

4. The method of claim 1, wherein the ratio of recycled shingles to asphalt binder is from about 10% to about 40%.

5. The method of claim 1, additionally comprising the step of constructing a road or pavement in a particular geographic location with the composite material; wherein the performance grade of the asphalt binder is one grade lower than the performance grade that would otherwise be optimal for an asphalt binder not mixed with recycled shingles in the particular geographic location.

6. A process for producing hot mix asphalt from recycled, asphalt-containing roofing shingles; asphalt binder; and aggregate; said process comprising the steps of:
(a) grinding the shingles to a powder, such that at least 50% by mass of the ground shingles pass a 200 mesh sieve;
(b) heating the asphalt binder to 185 to 200 degrees Celsius;
(c) blending the ground shingles with the heated asphalt binder; wherein the ground shingles are unheated immediately prior to said blending step; wherein no aggregate is included with the ground shingles and asphalt binder during said blending step; and wherein said blending step continues until substantially all asphalt from the ground shingles is melted and blended with asphalt from the asphalt binder; and
(d) mixing the melted blend of ground shingles and asphalt binder from step (c) with aggregate to produce hot mix asphalt.

7. The method of claim 6, additionally comprising the step of constructing a road or pavement in a particular geographic location with the hot mix asphalt; wherein the performance grade of the asphalt binder is one grade lower than the performance grade that would otherwise be optimal for an asphalt binder not mixed with recycled shingles in the particular geographic location.
